(19) United States
(12) Patent Application Publication
(10) Pub. No.: US 2013/0085826 A1
(43) Pub. Date: Apr. 4, 2013

(54) GAME SYSTEM AND METHOD OF PROVIDING INFORMATION

(71) Applicant: Tom Woolley, Denver, IA (US)

(72) Inventor: Tom Woolley, Denver, IA (US)

(21) Appl. No.: 13/248,512

(22) Filed: Sep. 29, 2011

(51) Int. Cl. G06Q 30/02

(52) U.S. Cl. 705/14.12; 705/14.73; 705/14.1

(57) ABSTRACT

A game system and method of providing information within a game. An advertising medium is provided that has indicia that is related to a product or a service and also includes a QR code that can be scanned by a computing device. The computing device then accesses a website that has a program where the retrieved information from the QR code is inputted so that a predetermined message such as a clue can be provided to a game player in order to determine a correct predetermined response in order to win a prize at the game.

### BACKGROUND OF THE INVENTION

This invention relates to a method of providing information. More specifically this invention relates to a method of embedding clues for a game within advertising.

Advertisers are always looking for a way to use modern technology in order to improve the visibility of their products and utilize technologies to improve sales. Specifically, with the invention of the Internet, web advertising at company webpages have been utilized where advertisements that are in print, billboards, and the like will now present web addresses to view company's websites to encourage people to buy and investigate into products. In addition, entire Internet communities have evolved based on certain websites such as Facebook, MySpace and the like where communities of individuals communicate with one another regarding social matters, including products. This has allowed companies to provide pages at these websites dedicated specifically to their products such that members can become fans and socially interact regarding products in the market place.

Still, as technology evolves additional means and methods are needed by companies to stay ahead of other companies in the market place. Thus, a continuous need for technologies that enhance advertising are constantly desired.

Therefore, a principal object of the present invention is to provide a game system and method for providing information related to products and services.

Yet another object of the present invention is to provide a game system and method of providing information that encourages a community of individuals to form in order to promote the sales of products and services.

These and other objects, advantages, and features will become from this disclosure and claims.

### BRIEF SUMMARY OF THE INVENTION

A method of providing information utilizing a game system. The method includes providing an advertising medium that has indicia related to a product or service that has a QR code embedded within the medium. A scanning device is then used in order to scan the QR code to retrieve information that is contained within the QR code. This information is then inputted into a program at a website on a server of a computing device where the program generates a predetermined message in response to the retrieved information. This information can be a clue such that once a plurality of clues are provided a player has the ability to input a predetermined response that, if correct, causes that player to win a prize.

### BRIEF DESCRIPTION OF THE DRAWINGS

FIG. 1 is a schematic diagram of a game system used for providing information; and

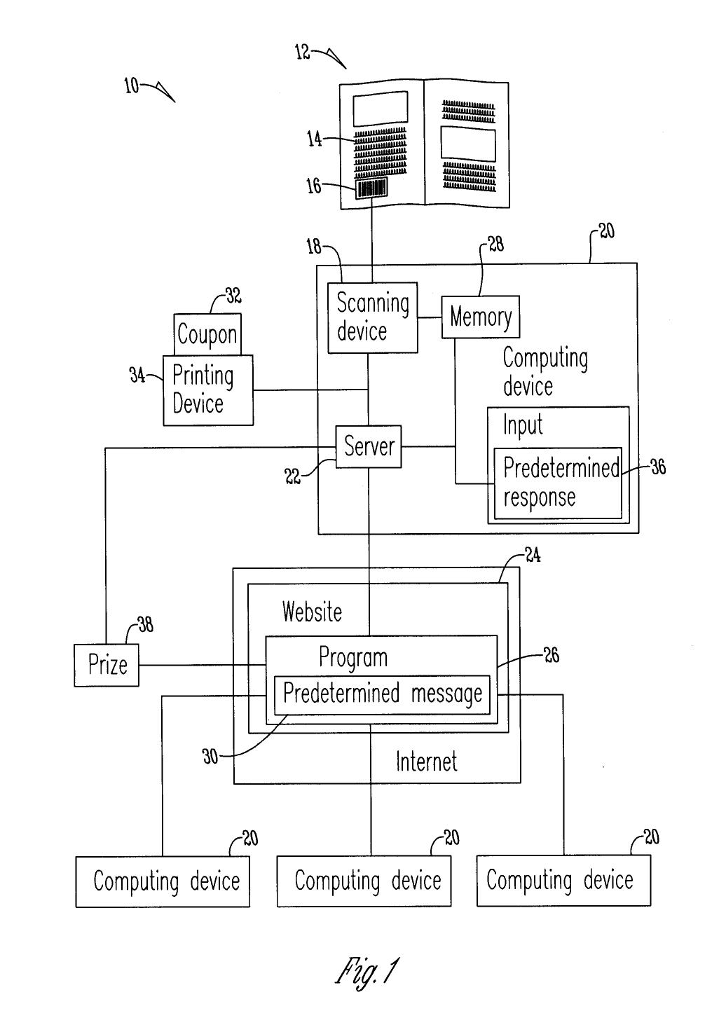

FIG. 2 is a flow diagram of a method of providing information;

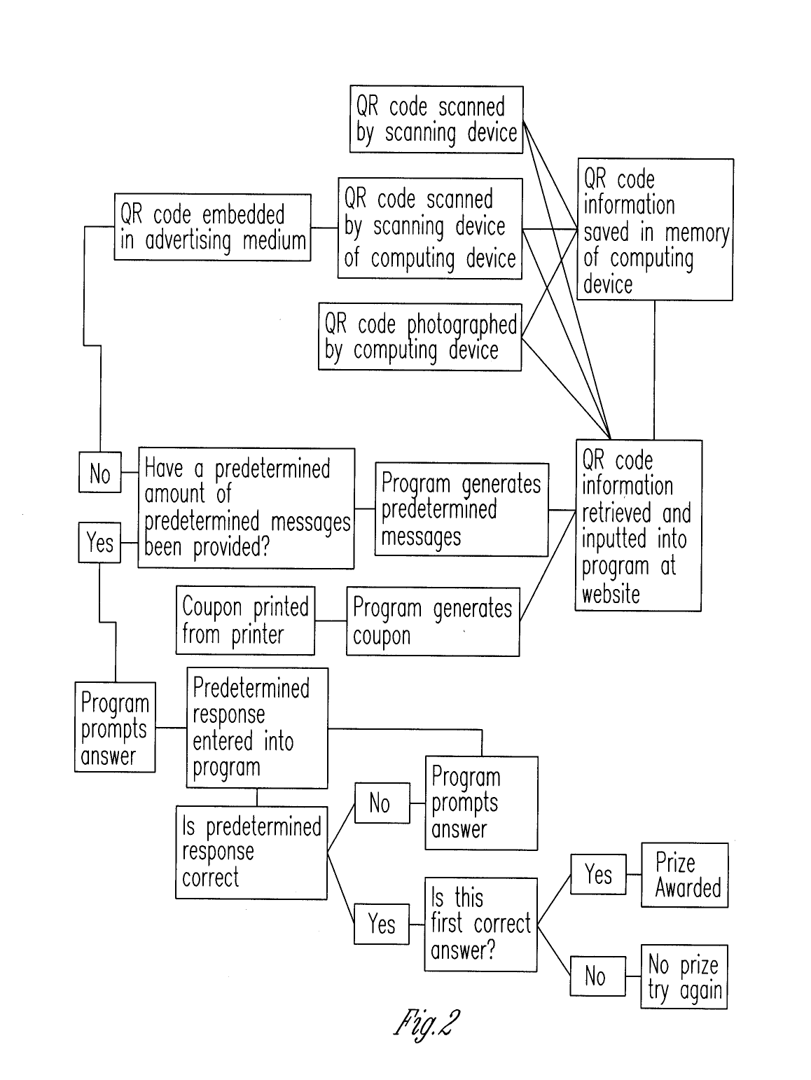

### DETAILED DESCRIPTION OF THE PREFERRED EMBODIMENT

The figures show a game system 10 that includes an advertising medium 12 that has indicia 14 related to a product or service thereon. The advertising medium 12 can include but is not limited to packaging, websites, billboards, print advertising, graphics and the like. Disposed on the advertising medium 12 within the indicia 14 is a quick response (QR) code 16. The QR code is a matrix barcode that is typically in two dimensions that can be read by a scanning device 18 of a computing device 20. The computing device can be a Smartphone, IPhone®, BlackBerry®, another hand held device or the like that contains a scanning device 18 capable of reading QR code 16. Alternatively the computing device 20 does not have to have a scanning device and instead can receive information associated via the QR code 16 from a scanning device 18 or another computing device. The computing device 20 can thus be a laptop or personal computer. Alternatively, the computing device 20 can take a picture of the advertising medium 12 in order to record the QR code 16 in order to provide the QR code 16 to the computing device 20.

The computing device 20 has a server 22 that provides over the internet communication to a website 24 that has a program 26 where the retrieved information from the scanning device 18 or taken from a picture can be inputted. Specifically, the computing device 20 additionally has a memory 28 such that if the computing device 20 has a scanning device 18 the scanning device 18 communicates the information scanned to the memory 28 that can then be inputted into the program 26 from the memory 28. Alternatively, the photograph can be saved in the memory of a computing device 20 that can then be connected to an additional computing device 20 via cable or as is known in the art in order to download the retrieved information from a computing device.

Program 26 can be accessed by a plurality of computing devices 20 such that each of the plurality of computing devices 20 communicate with the program and with one another over the internet. The program 26 requires a passcode, and for an individual to sign up they must provide personal information.

When the program 26 receives the retrieved information the program provides a predetermined message 30. The predetermined message 30 is related to a game that is to be played by individuals accessing the website 24. This predetermined message 30 can include clues, information to solve riddles, questions, tests, problems, and the like. Simultaneously, the program 24 in response to receiving the retrieved information can generate a coupon 32 associated with the product or service of the advertising medium 12. The coupon 32 can then be printed by a printing device 34 that is electrically connected to the computing device 20 and in communication with the program 26 in order to provide savings and rewards to an individual for using the website 24.

Next, based on the predetermined message 30 the individual will try to answer that clue, question, riddle, or the like with a predetermined response 36. When the predetermined response 36 is received by the program 26 the program 26, based on the response, awards a prize 38 to the individual that provides the predetermined response 36. This prize 38 can be a jackpot, money, discount, vacation, or the like to reward the individual for using the website 24. Specifically, the prize 38 and the amount of the prize is determined by the program 26 where the program 36 determines the amount of individuals that are providing the retrieved information and can determine who first provides a first predetermined response 36.

In operation, a plurality of individuals sign up at the website and provide their personal information to the program 26. The program 26 then provides communication pathways between all the individuals. Thus, the plurality of individuals then can seek out specific advertising medium 12 and search for advertising medium 12 that contains QR codes 16 therein. Once an individual recognizes a QR code 16 is within an advertising medium 12 the individual can use a computing device such as a Smartphone that has a scanning device 18 to scan the QR code 16. Alternatively, an individual can photograph such information with the phone. At this time the retrieved information is inputted into the program 26 and the program 26 generates a predetermined message 30 based on the retrieved information.

In an embodiment where the predetermined message 30 is a clue, the clue is provided to the individual so that they can attempt to figure out the correct predetermined response 36. In one embodiment the game involves the requirement of a plurality of clues to be provided to individuals playing the game. Specifically, every time that a QR code 16 is provided in advertising medium 12 individuals can scan the code and input it into the program 26 so that additional clues can be provided. In this manner an advertiser can release certain advertisements at certain times so that clues cannot be uncovered until the advertising is released.

Once all of the clues are provided by the advertiser the program 26 then allows an individual to present the predetermined response 36 that represents the correct answer to the clues that have been provided. If that predetermined response 36 is correct the first individual to provide the predetermined response 36 is then rewarded with a prize 38. The prize 38 is determined by the amount of individuals that have submitted the retrieved information, received clues, and based on factors that are associated with the game.

During the game play, individuals are able to communicate through the website 24 with one another and work as teams in order to attempt to determine the predetermined response 36 that is a correct response to win the prize 38. Similarly, individuals can purchase clues if they are unable to find the advertising containing the QR code 16 in order to play the game. In this manner individuals are encouraged to find the advertising and additionally based on the purchased clues the value of the prize 38 increases.

Thus, provided is a game system 10 that allows for a method of providing information regarding a game. The system utilizes QR code technology by vendors on packaging, websites, billboards, print advertising, and graphics that allows players or consumers that are making everyday purchases to receive clues and information to solve riddles, questions, tests, problems, and the like. Players advance by scanning or photographing the QR code 16 and checking against information on the website 24. At this time a player can be provided with printable coupons 32 good for prizes being awarded or additional clues in order to complete riddles to advance to win a prize 38 or jackpot.

Revenues are required for participating vendors and merchants by utilizing the existing advertising dollars of these companies and charges for the amount of activity on the webpage as a result of the use of the QR codes 16 issued to the merchants. This also causes consumers or players to be guided into stores for specials or sales or onto websites for specials and sales in order to find the hidden clues within the QR code 16.

In addition, the jackpot or prize 38 is advanced as a result of the percentage of individuals that are playing the game. The game rules themselves can be awarded toward the clue itself such that individuals can utilize their own personal skills in order to complete a sequence, solve a riddle, or answer a question in order to win the prize 38. As players advance a status is issued so that in chat rooms, blogs, tweets, twitters and persons with the most information gain status among players. By providing this information social alliances can form as well as adversaries in order to share information with players in the network. In a preferred embodiment the game consists of between 30-36 clues such that when all the clues are awarded the jackpot prize is awarded to the first correct answer entered at the website 24. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of providing information related to a game comprising:
providing an advertising medium having indicia related to a product or service with a QR code embedded within the medium;
retrieving information contained in the QR code for a computing device;
inputting the retrieved information in a program at a website on a server at the computing device; and
generating a predetermined message with the program in response to the retrieved information.

2. The method of claim 1 further comprising the steps of:
inputting a predetermined response into the program at the website on the computer related to the predetermined message; and
awarding a prize with the program based on the predetermined response.

3. The method of claim 2 wherein the program generates a prize certificate based on the predetermined response.

4. The method of claim 3 further comprising the step of printing the prize certificate with a printer that is electrically connected to the computing device.

5. The method of claim 4 wherein the predetermined message is a clue associated with the prize.

6. The method of claim 1 wherein when the retrieved information is inputted in the program the program generates a coupon associated with the product or service.

7. The method of claim 2 wherein the program determines the prize based on the retrieved information.

8. The method of claim 1 wherein the computing device is selected from a group consisting of smartphone, cell phone, IPhone®, BlackBerry® hand held device, laptop, and personal computer.

9. The method of claim 1 wherein a scanning device retrieves the information contained in the QR code.

10. The method of claim 9 wherein the scanning device is part of the computing device.

11. The method of claim 1 wherein the advertising medium is selected from the group consisting of billboard, webpage, print advertising, and packaging.

12. The method of claim 1 wherein a plurality of computing devices are in over the internet communication with the website such that individual computers are in communication with one another through the website.
